(19) United States
(12) Patent Application Publication
(10) Pub. No.: US 2011/0074134 A1
(43) Pub. Date: Mar. 31, 2011

(54) Qwik Fold Golf Push / Pull Cart

(76) Inventor: Jonathan Hwan Wang, Hayward, CA (US)

(21) Appl. No.: 12/789,840

(22) Filed: May 28, 2010

(30) Foreign Application Priority Data
Sep. 29, 2009 (CN) 200920236562.0

(51) Int. Cl. B62B 3/02

(52) U.S. Cl. 280/646

(57) ABSTRACT

The utility model involves golf cart technology, particularly related to a folding golf cart, which includes a car chassis, the main bar, push handle, folding bar. The main bar, connector, folding bar, and the car chassis together form a four-bar linkage, the connected action of the four-bar linkage moves other components involved in the action accordingly. During usage, press the button and push the push handle backward/downwards, which drives the main bar and the folding bar forward and closed, and makes the golf cart form into a Z shaped of three-panel folding state. This substantially reduces the size, saves space, and is convenient to store and transport. It is also a simple structure, easy to fold or open, and easy to operate.

### BACKGROUND OF THE INVENTION

The primary requirement is that golf carts must have a large enough framework to facilitate the different sizes of golf bags. Usually on a golf cart, the upper and lower brackets on the golf cart support the top and bottom of the golf bag. There needs to be enough space between the brackets in order to hold the golf bag. But this makes storage and transport of the golf cart difficult. Existing golf carts have car chassis, main bar, and push handle, several parts, which are all welded together, and therefore makes it hard for manufacturers to reduce the size of the golf cart during transportation and storage time, and as a result of that manufacturers must use more containers, more space or box storage in order to store the golf carts, increased transportation and storage cost; and for users, if the golf cart is not folded when not in use and put away when necessary, it takes up more space and results in inconvenience of storage.

### BRIEF SUMMARY OF THE INVENTION

The purpose of this new utility model aims to provide new technology to existing technologies. This new technology of folding golf cart provides an easier way to fold, transport, operate, and save more space. The utility model involves a golf cart technology, particularly related to folding golf cart, which includes a car chassis, the main bar, push handle, folding bar, the bottom of the main bar is hinged with the car chassis, the bottom of the push handle sits a connector, and at one end of this connector, it connects to the main bar near the top, and at the other end of the connector, it connects to the top of the folding bar, and on the other end of folding bar connects the car chassis. The main bar, connector, folding bar, and the car chassis together form a four-bar linkage, the connected action of the four-bar linkage moves other components involved in the action accordingly. During usage, press the button and push the push handle backward/downwards, which drives the main bar and the folding bar forward and closed, and makes the golf cart form into a Z shaped of three-panel folding state. This substantially reduces the size, saves space, and is convenient to store and transport. It is also a simple structure, easy to fold or open, and easy to operate.

### BRIEF DESCRIPTION OF THE DRAWINGS

FIG. 1 is a schematic diagram of the structure of a utility model;

FIG. 2 is a locking device of the utility model;

FIG. 3 is the folded state of the utility model structure diagram.

### DETAILED DESCRIPTION OF THE INVENTION

The purpose of this new utility model aims to provide new technology to existing technologies. This new technology of folding golf cart provides an easier way to fold, transport, operate, and save more space.

The utility model includes a car chassis, the main bar, push handle, folding bar, the bottom of the main bar is hinged with the car chassis, the bottom of the push handle sits a connector, and at one end of this connector, it connects to the main bar near the top, and at the other end of the connector, it connects to the top of the folding bar, and on the other end of folding bar connects the car chassis. The main bar, connector, folding bar, and the car chassis together form a telescopic four-bar linkage. In addition, the utility model also includes the following key features:
a parallel four-bar linkage described four-bar linkage
push handle as described has a protective sheath
towards the top of the main bar exists a locking device to lock the main bar with the fixed connector

The locking device includes the holder, button, reset spring, card column, holder set up to accommodate the internal cavity, button slide set up cavity, the top of the button pierces out of the holder, the top of the reset spring sits between the internal cavity and the button, card column fixed to the button, the holder and card column corresponds to the external surface of the cavity opening of internal cavity, connector is equipped with a hook, which hooks into the opening of holder inserted into the internal cavity and hooks onto the card column.

The utility model is a beneficial effect: which includes a car chassis, the main bar, push handle, folding bar, the bottom of the main bar is hinged with the car chassis, the bottom of the push handle sits a connector, and at one end of this connector, it connects to the main bar near the top, and at the other end of the connector, it connects to the top of the folding bar, and on the other end of folding bar connects the car chassis. The main bar, connector, folding bar, and the car chassis together form a four-bar linkage, the connected action of the four-bar linkage moves other components involved in the action accordingly. During usage, press the button and push the push handle backward/downwards, which drives the main bar and the folding bar forward and closed, and makes the golf cart form into a Z shaped of three-panel folding state. This substantially reduces the size, saves space, and is convenient to store and transport. It is also a simple structure, easy to fold or open, and easy to operate.

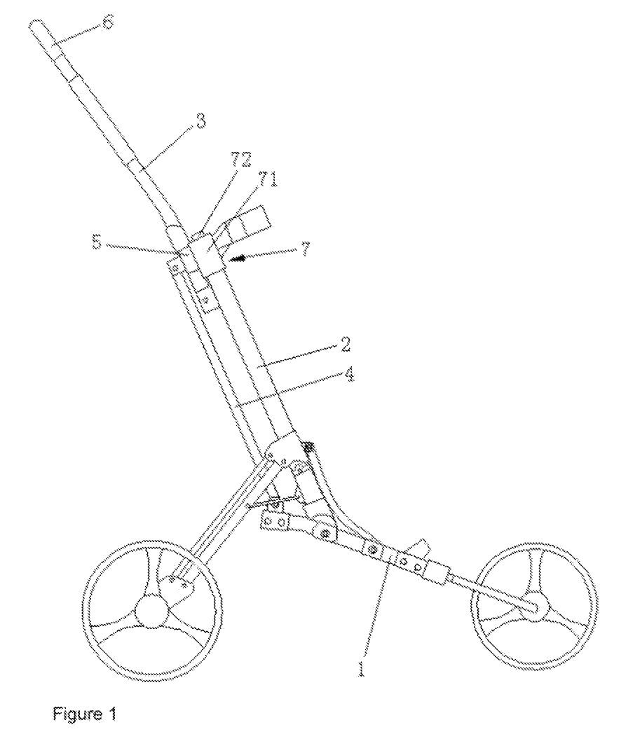

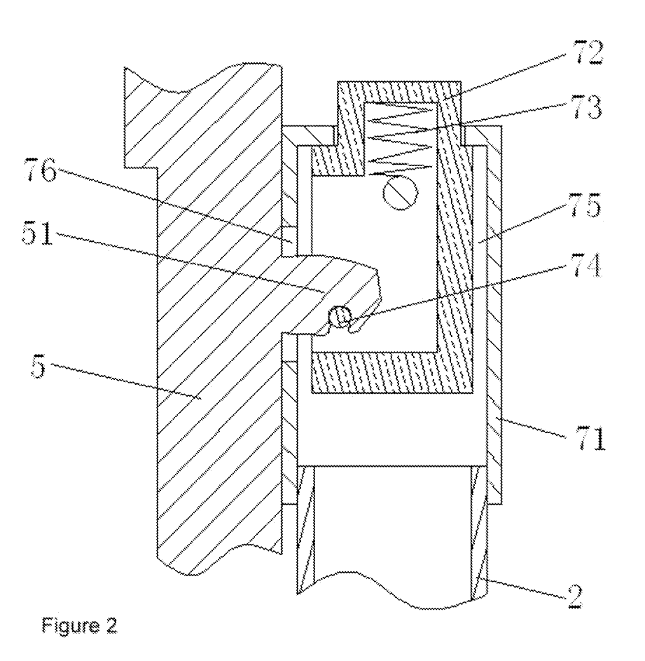

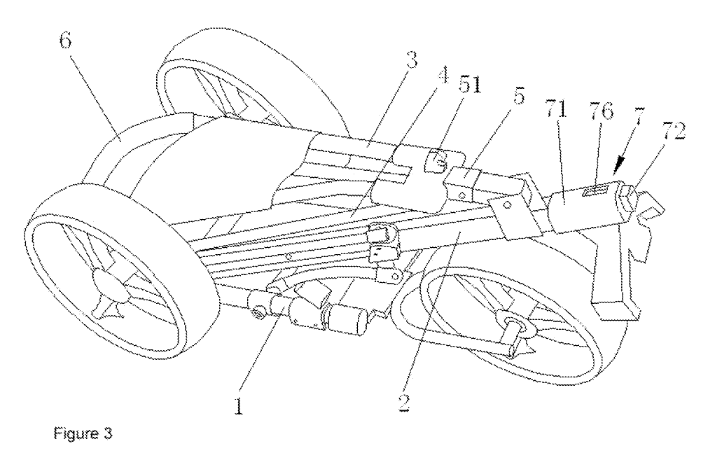

The following photos of the utility model combined with further instructions, as shown in FIGS. 1 to 3, folding golf cart, which includes a car chassis (1), the main bar (2) and the push handle (3), characterized in that: it also includes a folding bar (4), the bottom of main bar (2) connects to the chassis (1), the bottom of the push handle (3) sits a connector (5), and at one end of the connector (5), hinges the top of the main bar (2), and at one end of the connector (5), it connects to the folding bar (4), and the other end of the folding bar (4) hinges to the car chassis (1). The movement of the main bar (2), connector (5), folding bar (4) and car chassis (1) together can trigger the movement of the entire golf cart with the free telescopic folding four-bar linkage. The four-bar linkage is a parallel linkage, with a stable structure, smooth transmission. The connector 5 of the four-bar linkage can trigger the movement of other components accordingly. Push handle 3 has a protective sheath 6 to increase the friction between fingers and makes it more comfortable to use.

The top of the main bar (2) has a fixed connector (5) for the locking device (7). The locking device (7) including the holder (71), button (72), reset spring (73), card column (74), holder (71) set up to accommodate the internal cavity (75), button (72) slide set up cavity (75), the top of the button (72) pierces out of the holder (71) the top of the reset spring (73) sits between the internal cavity (75) and the button (72), card column (74) fixed to the button (72), the holder (71) and card column (74) corresponds to the external surface of the cavity opening (76) of internal cavity (75), connector (5) is equipped with a hook (51), which hooks into the opening (76) of holder (71) inserted into the internal cavity (75) and hooks onto the card column (74).

In the expanded state the hook (51) locks onto card column (74) that sits in the locking device (7), which will fix the four-bar linkage; and when the cart needs to be fold, press the button (72) and the hook (51) releases from the card column (74), which sits in the locking device (7) and releases the connector (5). This allows for the free movement of the four-bar linkage and can facilitate folding.

To fold the golf cart, press the button and push the push handle backward/downwards, which drives the main bar and the folding bar forward and closed, and makes the golf cart form into a Z shaped of three-panel folding state. Only one action is needed for all of the retractable folding, collapse or expand the easy to use and convenient operation of the cart. This substantially reduces the size, saves space, and is convenient to store and transport. It is also a simple structure, easy to fold or open, and easy to operate.

Of course, the above is just a sample case of the implementation of this utility model, so any area under this utility model patent application as described in the structure, characteristics and principle of equivalent changes or modifications made are included in the utility model patent application range.

1. The folding golf cart, which includes a car chassis (1), the main bar (2) and the push handle (3), characterized in that: it also includes a folding bar (4), the bottom of main bar (2) connects to the chassis (1), the bottom of the push handle (3) sits a connector (5), and at one end of the connector (5), hinges the top of the main bar (2), and at one end of the connector (5), it connects to the folding bar (4), and the other end of the folding bar (4) hinges to the car chassis (1). The movement of the main bar (2), connector (5), folding bar (4) and car chassis (1) together can trigger the movement of the entire golf cart with the free telescopic folding four-bar linkage.

2. According to claim #1 of the folding golf cart, characterized in that: a parallel four-bar linkage described four-bar linkage.

3. According to claim #1 of the folding golf cart, characterized in that: push handle as described (3) has a protective sheath (6).

4. According to any of claims #1-#3, a folding golf cart as described, characterized in that: towards the top of the main bar (2) for locking the top with fixed connector (5) of the locking device (7).

5. As described in claim #4, a folding golf cart, characterized in that: the locking device (7) including the holder (71), button (72), reset spring (73), card column (74), holder (71) set up to accommodate the internal cavity (75), button (72) slide set up cavity (75), the top of the button (72) pierces out of the holder (71) the top of the reset spring (73) sits between the internal cavity (75) and the button (72), card column (74) fixed to the button (72), the holder (71) and card column (74) corresponds to the external surface of the cavity opening (76) of internal cavity (75), connector (5) is equipped with a hook (51), which hooks into the opening (76) of holder (71) inserted into the internal cavity (75) and hooks onto the card column (74).
